(19) United States
(12) Patent Application Publication
(10) Pub. No.: US 2011/0194163 A1
(43) Pub. Date: Aug. 11, 2011

(54) IMAGE DISPLAY DEVICE AND HEAD-MOUNTED DISPLAY

(75) Inventors: Yoshie Shimizu, Ibaraki-shi (JP); Yasushi Tanijiri, Osakasayama-shi (JP)

(73) Assignee: Konica Minolta Opto, Inc., Hachioji-shi, Tokyo (JP)

(21) Appl. No.: 13/125,227

(22) PCT Filed: Nov. 25, 2009
(86) PCT No.: PCT/JP2009/069831

§ 371 Date: Apr. 20, 2011

(30) Foreign Application Priority Data
Nov. 26, 2008 (JP) 2008-300502

(51) Int. Cl. G02B 5/32

(52) U.S. Cl. 359/15

(57) ABSTRACT

A total reflection surface and a holographic optical element (HOE) surface are formed on the same surface (S3) in an eyepiece prism (15). In this structure, a smaller reflection angle can be set at an HOE (16) compared to a structure with the surface formed separately, and the HOE surface of the surface (S3) can be set in the direction parallel to a surface (S2). Thus, even in a structure in which at least a portion of the light flux of the image light fully reflected by the surface (S3) is incident on an affixing region (R1) of a hologram photosensitive material (16a), that portion of the light can be prevented from falling incident on the optical pupil (E) as ghost light. Consequently, in order to prevent the generation of ghost light, an optical path margin no longer needs to be provided between the diffraction and reflection region of the HOE (16) and the total reflection region of the image light; and the eyepiece prism (15) can be thinned by that amount. In addition, since a smaller reflection angle can be set at the HOE (16), the color dispersion caused by diffraction by the HOE (16) can also be reduced, and the image quality can be maintained.

### TECHNICAL FIELD

The present invention relates to an image display device that directs image light from a display element through an eyepiece optical system to an optical pupil in order to thereby allow a viewer to observe a displayed image (virtual image) at the position of the optical pupil. The present invention also relates to a head-mounted display (hereinafter also referred to as a HMD).

### BACKGROUND ART

An image display device that directs image light from a display element through an eyepiece optical system to an optical pupil is disclosed, for example, in Patent Document 1 listed below. In this image display device, the eyepiece optical system includes an eyepiece prism, which has an entrance surface S11, two opposite surfaces S12 and S13 disposed opposite from each other, and a HOE surface S14 on which a hologram optical element is formed. Part of one opposite surface S12 serves as an exit surface as well. With this construction, the image light from a display element enters the eyepiece prism through the entrance surface S11, is then directed, by being totally reflected between the two opposite surfaces S12 and S13, to the HOE surface S14, is then diffraction-reflected on the HOE surface S14, and is thus directed, through the exit surface, to the optical pupil. This allows a viewer to observe, at the position of the optical pupil, a virtual image of the image displayed on the display element.

### LIST OF CITATIONS

### Patent Literature

Patent Document 1: JP-A-2004-61731

### SUMMARY OF INVENTION

### Technical Problem

Inconveniently, however, in the image display device disclosed in Patent Document 1, the opposite surfaces S12 and S13 are disposed parallel to each other, and in addition one opposite surface S13 and the HOE surface S14 are formed as separate surfaces (discontinuous surfaces); moreover, the HOE surface S14 is so inclined that its distance from the opposite surface S12 continuously decreases away from the entrance surface S11. With this construction, if part of the rays that should be incident on the opposite surface S13 are, due to an error in the inclination of a surface in the eyepiece optical system or a displacement of the display element, diffracted on the HOE surface S14, they become ghost light and are incident on the optical pupil. To prevent this, it is necessary to ensure that the beam incident on the opposite surface S13 is separated from the beam incident on the HOE surface S14. To achieve that, it is necessary to secure a space (optical path margin) for separating those beams near the boundary between the opposite surface S13 and the HOE surface S14. Disadvantageously, securing this optical path margin makes the eyepiece optical system thicker.

Specifically, as shown in FIG. 14, in the eyepiece optical system 101, if a ray L11 at the bottom end of the image region (screen) which is incident on the optical pupil E at its bottom end is, due to an error in inclination etc. mentioned above, incident on the HOE surface S14, on which a HOE 102 is formed, that ray L1, since its angle of incidence is close to the angle of incidence of a ray L12 at the top end of the image region which is incident on the optical pupil E at its top end, is incident on the optical pupil E as ghost light. To suppress occurrence of such ghost light, it is necessary to secure an optical path margin P for separating the rays L11 incident on the opposite surface S13, which is a total reflection surface, from the rays L12 incident on the HOE surface S14. And securing the optical path margin P makes the eyepiece optical system 101 accordingly thicker.

On the other hand, if the angle of diffraction of the image light on the HOE 102 is large, the color dispersion caused by diffraction on the HOE 102 is large, leading to lower image quality. This too, therefore, needs to be taken into consideration in attempting to make the eyepiece optical system 101 slim.

The present invention has been made to overcome the inconveniences discussed above, and it is an object of the invention to provide an image display device that, while maintaining satisfactory image quality, prevents occurrence of ghost light and in addition permits an eyepiece prism to be made slim, and to provide a HMD incorporating such an image display device.

### Solution to Problem

According to one aspect of the invention, an image display device includes: a display element for displaying an image; and an eyepiece optical system for directing t image light from the display element to an optical pupil, the eyepiece optical system including an eyepiece prism having a surface S1 on which the image light is incident, a surface S2 which is disposed toward the optical pupil, and a surface S3 which is disposed opposite from the surface S2. Here, on part of the surface S3, a volume-phase reflective holographic optical element is formed; the image light from the display element enters the eyepiece prism through the surface S1, is then totally reflected on the surface S3 at least once, is then totally reflected on the surface S2, and is then diffraction-reflected by the holographic optical element on the surface S3 so as to be directed to the optical pupil; when an axis optically connecting the center of the display screen of the display element to the center of the optical pupil is defined as the optical axis, and a plane including the optical axis of the light incident on the surface S3 and the optical axis of the light emergent from the surface S3 is defined as the optical axis incidence plane, then the eyepiece prism is shaped symmetrically about the optical axis incidence plane and is so shaped that the distance between the surfaces S2 and S3 continuously decreases away from the surface S1; and at least part of the beam of the image light totally reflected on the surface S3 is incident on the attachment region of an hologram photosensitive material where the holographic optical element is produced.

According to another aspect of the invention, an image display device includes: a display element for displaying an image; and an eyepiece optical system for directing image light from the display element to an optical pupil, the eyepiece optical system including an eyepiece prism having a surface S1 on which the image light is incident, a surface S2 which is disposed toward the optical pupil, and a surface S3 which is disposed opposite from the surface S2. Here, on the surface S3, a first volume-phase reflective holographic optical element and a second volume-phase reflective holographic optical element are formed; the image light from the display element enters the eyepiece prism through the surface S1, is then diffraction-reflected by the first holographic optical element on the surface S3 at least once, is then totally reflected on the surface S2, and is then diffraction-reflected by the second holographic optical element on the surface S3 so as to be directed to the optical pupil; when an axis optically connecting the center of the display screen of the display element to the center of the optical pupil is defined as the optical axis, and a plane including the optical axis of light incident on the surface S3 and the optical axis of light emergent from the surface S3 is defined as the optical axis incidence plane, then the eyepiece prism is shaped symmetrically about the optical axis incidence plane and is so shaped that the distance between the surfaces S2 and S3 continuously decreases away from the surface S1; and part of the beam of the image light diffraction-reflected by the first holographic optical element is incident on a diffraction-reflection region of the second holographic optical element.

In an image display device according to the invention, it is preferable that the effective diffraction region within the attachment region of the hologram photosensitive material where the holographic optical element is, or the holographic optical elements are, produced be set by restricting the exposed region within the attachment region.

In an image display device according to the invention, the attachment region of the hologram photosensitive material where the holographic optical element is produced may include a diffraction-reflection region and a total reflection region for the image light on the surface S3.

In an image display device according to the invention, the attachment region of the hologram photosensitive material where the second holographic optical element is produced may include the diffraction-reflection region of the second holographic optical element and a diffraction-reflection region of the first holographic optical element.

In an image display device according to the invention, in part of the hologram photosensitive material, interference fringes for the first holographic optical element and interference fringes for the second holographic optical element may both be formed by multiple exposure.

In an image display device according to the invention, the surface S3 may have a curvature only on the optical axis incidence plane.

In an image display device according to the invention, it is preferable that it further include a correction prism for canceling refraction of light of an outside world image in the eyepiece prism, and that any joint line along which the eyepiece prism and the correction prism are joined together be located on a side face that intersects a surface through which the light of the outside world image is transmitted.

In an image display device according to the invention, it is preferable that it further include a correction prism for canceling the refraction of light of an outside world image in the eyepiece prism, and that at least one of the eyepiece prism and the correction prism include a positioning portion for joining together the eyepiece prism and the correction prism at a predetermined interval from each other with a layer of air in between.

In an image display device according to the invention, the surface S3 may be a flat surface.

According to yet another aspect of the invention, a head-mounted display includes: an image display device according to the invention as described above; and support means for supporting the image display device in front of the eye of a viewer.

### Advantageous Effects of the Invention

According to the invention, the eyepiece prism has a total reflection surface and a HOE surface formed on the same surface S3, and in addition is so shaped that the distance between the surfaces S2 and S3 continuously decreases away from the surface S1. With this construction, as compared with one where total reflection surfaces are disposed parallel to each other and in addition a total-reflection part of the surface S3 and a HOE part are formed separately, even when a HOE surface is set up in a direction parallel to the surface S2, it is possible to reduce the angle of incidence of the image light on the HOE, and thus to reduce the angle of reflection (diffraction) on the HOE. By reducing the angle of diffraction on the HOE, it is possible to keep the color dispersion caused by diffraction small, and thus it is possible, while maintaining satisfactory image quality, to make the eyepiece prism slim.

Moreover, owing to the eyepiece prism being so shaped that the distance between the surfaces S2 and S3 continuously decreases away from the surface S1, even in a construction where at least part of the beam of the image light totally reflected on the surface S3 is incident on the attachment region of the hologram photosensitive material, since the angle of incidence differs between ghost light and the light diffracted on the HOE, it is possible, with the angle selectivity of the HOE, to prevent ghost light from being incident on the optical pupil.

It is thus no longer necessary, for the purpose of reducing the angle of incidence on a HOE, or with a view to preventing occurrence of ghost light, to give the HOE a large inclination, or secure an optical path margin. This makes it possible to make the eyepiece prism accordingly slimmer. That is, with the construction described above, it is possible, while maintaining satisfactory image quality, to prevent occurrence of ghost light and in addition make the eyepiece prism slim.

### BRIEF DESCRIPTION OF DRAWINGS

FIG. 1 shows, with enlargement, the construction of an image display device according to one embodiment of the invention, and is a sectional view showing, with enlargement, part A in FIG. 2.

FIG. 2 is a sectional view showing an outline of the construction of the image display device.

FIG. 3 is a diagram illustrating the spectral intensity distribution of a light source in the image display device.

FIG. 4 is a diagram illustrating the wavelength dependence of the diffraction efficiency on an HOE in the image display device.

FIG. 5 is a schematic sectional view of an eyepiece prism in an eyepiece optical system in the image display device.

FIG. 6 is a perspective view of an image display device incorporating another eyepiece prism.

FIG. 7 is a sectional view showing an outline of the construction of a production optical system for producing the HOE.

FIG. 8 is a sectional view showing another construction of the image display device.

FIG. 9 is a sectional view showing yet another construction of the image display device.

FIG. 10 is a sectional view showing an outline of the construction of an image display device according to another embodiment of the invention.

FIG. 11 is a sectional view showing an outline of the construction of an image display device according to yet another embodiment of the invention.

FIG. 12 is a sectional view showing another construction of the image display device.

FIG. 13 is a perspective view showing an outline of the construction of an HMD according to still another embodiment of the invention.

FIG. 14 is a sectional view of a relevant part of a conventional image display device.

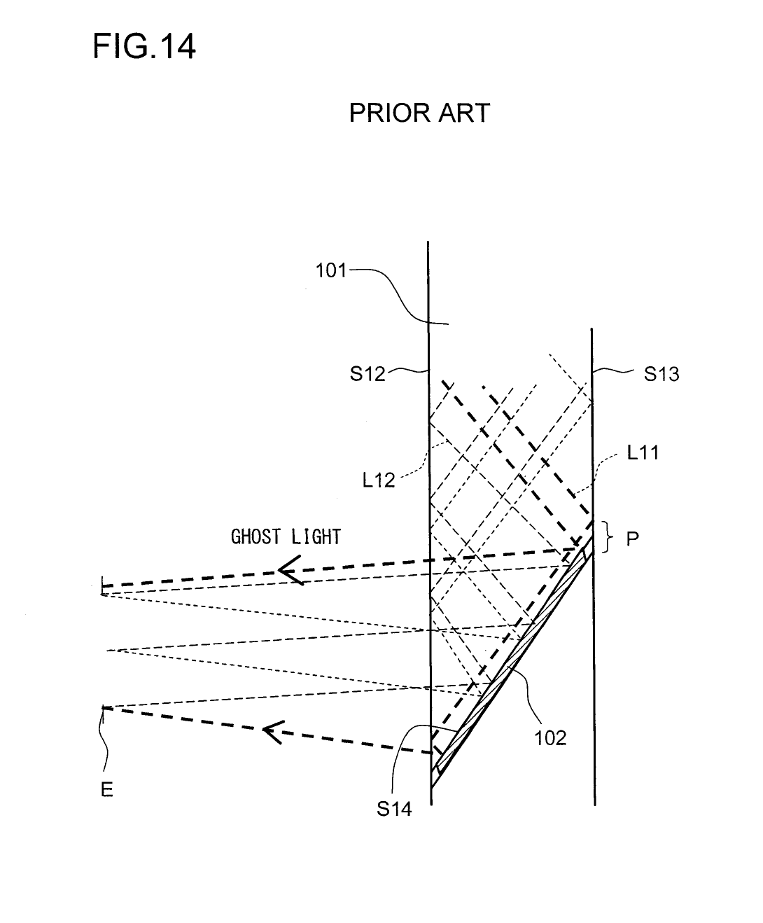

### DESCRIPTION OF EMBODIMENTS

### Embodiment 1

An embodiment of the invention will be described below with reference to the accompanying drawings.

(Image Display Device)

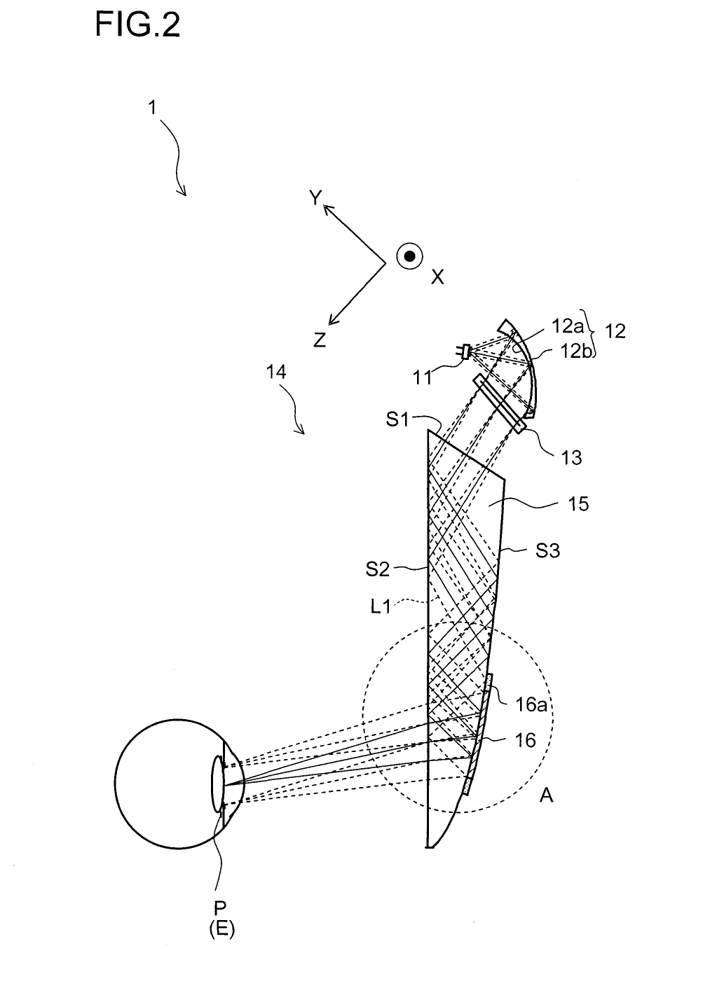

FIG. 2 is a sectional view showing an outline of the construction of an image display device 1 according this embodiment. This image display device 1 generates an image to present it as a virtual image to a viewer and in addition permits the viewer to observe an outside world image on a see-through basis. The image display device 1 includes a light source 11, an illumination optical system 12, a display element 13, and an eyepiece optical system 14.

For convenience's sake, the following description uses the following terminology. The axis that optically connects the center of the light source 11 to the center of the display screen (image region) on the display element 13 to the center of the optical pupil (exit pupil) formed by the eyepiece optical system 14 is referred to as the optical axis. The direction of the optical axis from the light source 11 to the optical pupil E, as it is when straightened, is taken as the Z direction. The direction perpendicular to the optical axis incidence plane of a surface S3 of an eyepiece prism 15, which will be described later, is taken as the X direction, and the direction perpendicular to the ZX plane is taken as the Y direction. It should be noted that the optical axis incidence plane of the surface S3 denotes the plane on which lie both the optical axis of the light incident on the surface S3 and the optical axis of the light reflected from the surface S3; that is, it denotes the YZ plane.

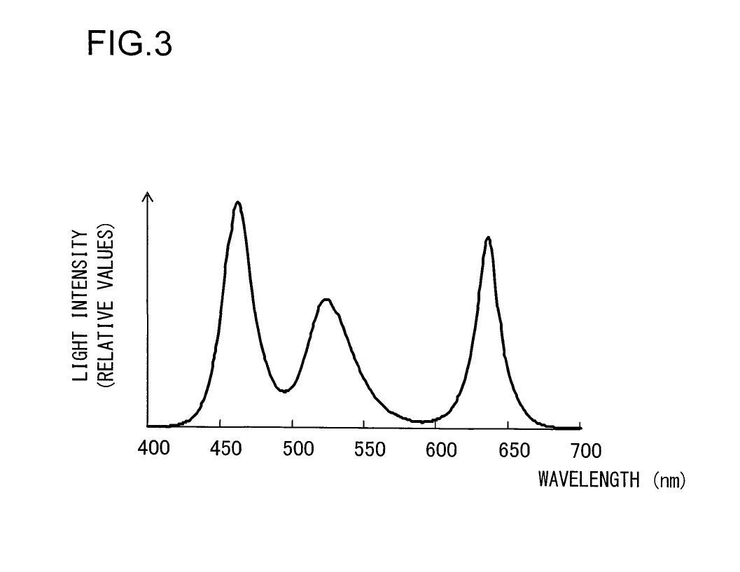

The light source 11 is, for example, composed of light-emitting diodes (LEDs) that emit light of wavelengths corresponding to three primary colors, namely R (red), G (green), and B (blue). FIG. 3 is a diagram illustrating the spectral intensity distribution of the light source 11, that is, the relationship between the wavelength and intensity of the light emitted. The light source 11 emits light in three wavelength bands of, for example, 465±12 nm, 520±19 nm, and 635±10 nm as expressed in terms of the center wavelength combined with the wavelength width at half the maximum intensity. In FIG. 3, the intensity, taken along the vertical axis, is given in values relative to the maximum intensity of B light taken as 100. The R, G, and B light intensities of the light source 11 are adjusted with consideration given to the diffraction efficiency of a HOE 16, which will be described later, and the light transmittance of the display element 13, and this enables display of white color.

The light source 11 is disposed in a positionally conjugate relationship with the optical pupil E. This leads to high use efficiency of the light from the light source 11 (allows the light from the light source 11 to be incident on the optical pupil E efficiently), and permits the viewer to observe a bright image. In other words, it is possible to realize an image display device 1 with low power consumption. The image display device 1 may incorporate a single set of light sources having R, G, and B light-emitting portions respectively, or may incorporate two or more such sets.

The illumination optical system 12 is an optical system that directs the light from the light source 11 to the display element 13. In this embodiment, it is composed of a back-surface-reflection mirror that has a refractive surface 12a on the front and a reflective surface 12b on the back. The refractive surface 12a and the reflective surface 12b are each a concave surface that has a positive optical power on the YZ plane, that is disposed eccentrically (decentered) with respect to the optical axis, and that is concave toward the light source 11 and the display element 13. Specifically, the refractive surface 12a is a cylindrical surface that has an optical power only on a plane parallel to the YZ plane, and the reflective surface 12b is a cylindrical aspherical surface that has an optical power only on a plane parallel to the YZ plane. The refractive surface 12a and the reflective surface 12b may each be a rotation-symmetric spherical surface, rotation-symmetric aspherical surface, or a free-form surface.

Between the illumination optical system 12 and the display element 13, there may additionally be provided a unidirectional diffuser plate that diffuses the incident light in one direction (for example, the X direction). Providing the unidirectional diffuser plate makes it possible, in a case where the set of light sources having R, G, and B light-emitting portions which compose the light source 11 are arranged in a row in the X direction, to mix the R, G, and B light from the light source 11 in the X direction. It is thus possible to reduce color unevenness due to the light-emitting portions being arranged at different positions, and it is also possible, owing to the diffusion by the unidirectional diffuser plate, to enlarge the optical pupil E in one direction.

In a case where a unidirectional diffuser plate is provided, even when the light source 11 and the optical pupil E are disposed in a positionally conjugate relationship with each other, they are not optically conjugate with each other in the X direction, but are still optically conjugate with each other in the Y direction. Thus, in the Y direction, it is possible to direct the light from the light source 11 to the optical pupil E efficiently.

Instead of the unidirectional diffuser plate mentioned above, an ordinary diffuser plate may be provided that diffuses the incident light in all directions. In this case, the position of the diffuser plate may be taken as the light source position (the secondary light source position), and this light source position may be disposed in a positionally conjugate relationship with the optical pupil E.

The display element 13 modulates the incident light according to image data to display an image, and is composed of, for example, a transmissive LCD. The display element 13 has a rectangular display screen (image region), and is disposed with its longer- and shorter-side directions aligned with the X and Y axes respectively.

The eyepiece optical system 14 is an optical system which directs the image light from the display element 13 to the optical pupil E, and includes an eyepiece prism 15 that guides the image light inside it. The eyepiece prism 15 has three optical surfaces, namely surfaces S1, S2, and S3, and has a shape symmetric about the YZ plane.

The surface S1 is an entrance surface through which the image light enters. The surface S2 serves both as a total reflection surface on which the image light is totally reflected and as an exit surface through which the image light after being diffraction-reflected by a HOE 16, which will be described later, emerges toward the optical pupil E. The surface S2 is, for example, a flat surface and is disposed on the optical pupil E side of the surface S3. The surface S3 is a surface having a total reflection surface and a HOE surface (the surface on which a HOE 16 is formed) formed continuously, and is disposed opposite from the surface S2. In this embodiment, the surface S3 is a surface having a curvature only on the YZ plane. In this embodiment, the eyepiece prism 15 has a tapering shape, meaning that it is so shaped that the distance between the surfaces S2 and S3 continuously decreases away from the surface S1. This shape will be described in detail later.

On part of the surface S3, a HOE 16 is formed which is a volume-phase reflective holographic optical element. The HOE 16 directs the image light from the display element 13 to the optical pupil E by diffraction-reflecting it. The HOE 16 has an axis-asymmetric positive optical power, and functions in a similar manner to an aspherical concave-surface mirror.

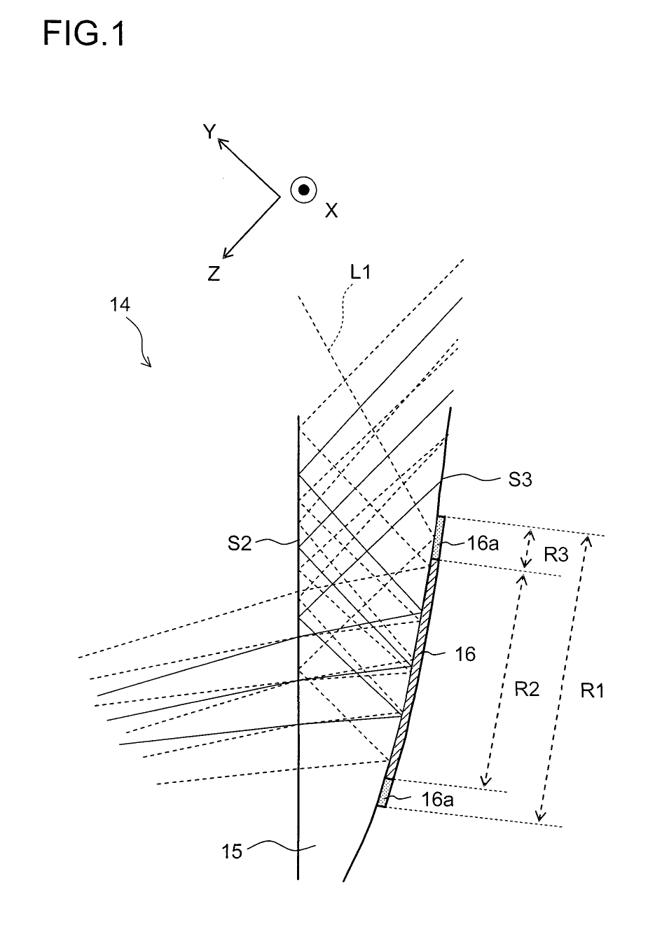

FIG. 1 is a sectional view showing, with enlargement, part A in FIG. 2. The HOE 16 is produced by exposing a hologram photosensitive material 16a to two beams (irradiating it with two beams). In this embodiment, the hologram photosensitive material 16a is attached on the surface S3 in such a way that at least part (for example, rays L1) of the beam of the image light totally reflected on the surface S3 is incident on the attachment region R1 of the hologram photosensitive material 16a (meaning the region across which the hologram photosensitive material 16a is attached). So long as the just mentioned at least part of the image light is incident within the attachment region R1 on the hologram photosensitive material 16a, it does not matter whether that part of the image light is incident on a region R2 or a region R3. The region R2 is an effective diffraction region, which is the region within the attachment region R1 where the HOE 16 is formed. On the other hand, the region R3 is the region within the attachment region R1 which is located outside the region R2. How the HOE 16 is produced will be described in detail later.

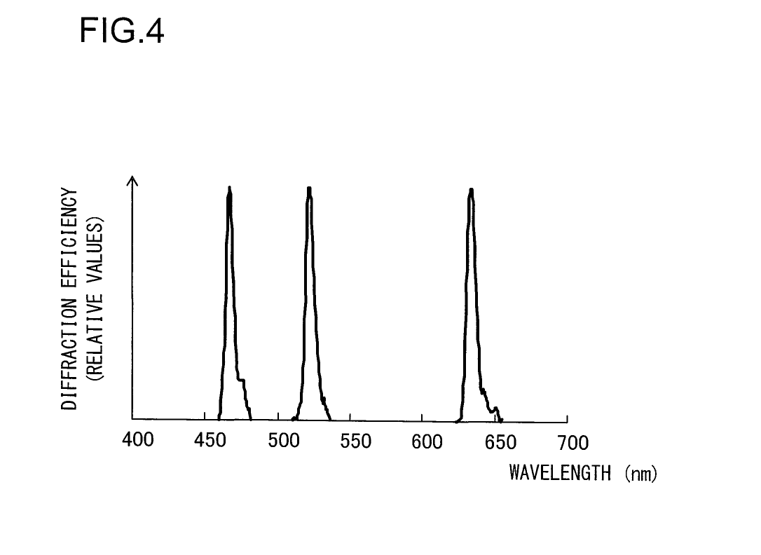

FIG. 4 is a diagram illustrating the wavelength dependence of the diffraction efficiency on the HOE 16. As shown there, the HOE 16 is so produced as to diffract (reflect) light in three wavelength bands of 465±5 nm (B light), 521±5 nm (G light), and 634±5 nm (R light) as expressed in terms of the diffraction efficiency peak wavelength combined with the wavelength width at half the diffraction efficiency peak level. A diffraction efficiency peak wavelength here denotes the wavelength at which the diffraction efficiency peaks, and a wavelength width at half a peak diffraction efficiency level is the wavelength width within which the diffraction efficiency is half its peak level or more. In FIG. 4, the diffraction efficiency is given in values relative to the maximum diffraction efficiency for B light taken as 100.

As will be understood from FIGS. 3 and 4, the peak wavelengths of the diffraction efficiency on the HOE 16 are substantially equal to the peak wavelengths (center wavelengths) of the intensity of the light emitted from the light source 11. This allows, of the light emitted from the light source 11 (the light constituting the image light), the parts at and around the wavelengths at which its intensity peaks to be efficiently diffracted on the HOE so as to be directed to the optical pupil E.

Next, how the image display device 1 constructed as described above operates will be described with reference to FIG. 2. The light emitted from the light source 11 is refracted at the refractive surface 12a of the illumination optical system 12, is then reflected on the reflective surface 12b, and is then refracted again at the refractive surface 12a so as to be directed to the display element 13. The light enters the display element 13, is modulated while passing through it, and leaves it as image light. The image light from the display element 13 then enters the eyepiece prism 15 in the eyepiece optical system 14 through the surface S1, is then totally reflected several times between the surfaces S2 and S3, and is then incident on the HOE 16 on the surface S3. Here, at least part of the image light totally reflected from the surface S3 is incident on the attachment region R1 (see FIG. 1) of the hologram photosensitive material 16a.

The light has to be totally reflected on the surface S3 at least once. The image light from the surface S1 may, for example, (1) be totally reflected on the surface S3, then totally reflected on the surface S2, and then incident on the HOE 16 on the surface S3, or (2) be totally reflected on the surface S2, then totally reflected on the surface S3, then totally reflected on the surface S2 again, and then incident on the HOE 16 on the surface S3.

The HOE 16 has such wavelength selectivity as to function as a diffractive element only for light of wavelengths corresponding to the emission wavelengths of the light source 11, and thus functions as a concave reflective surface only for light of those wavelengths. Accordingly, the light incident on the HOE 16 is diffraction-reflected by it so as to reach the optical pupil E. Thus, when the pupil P of a viewer is placed at the position of the optical pupil E, the viewer can observe an enlarged virtual image of the image displayed on the display element 13.

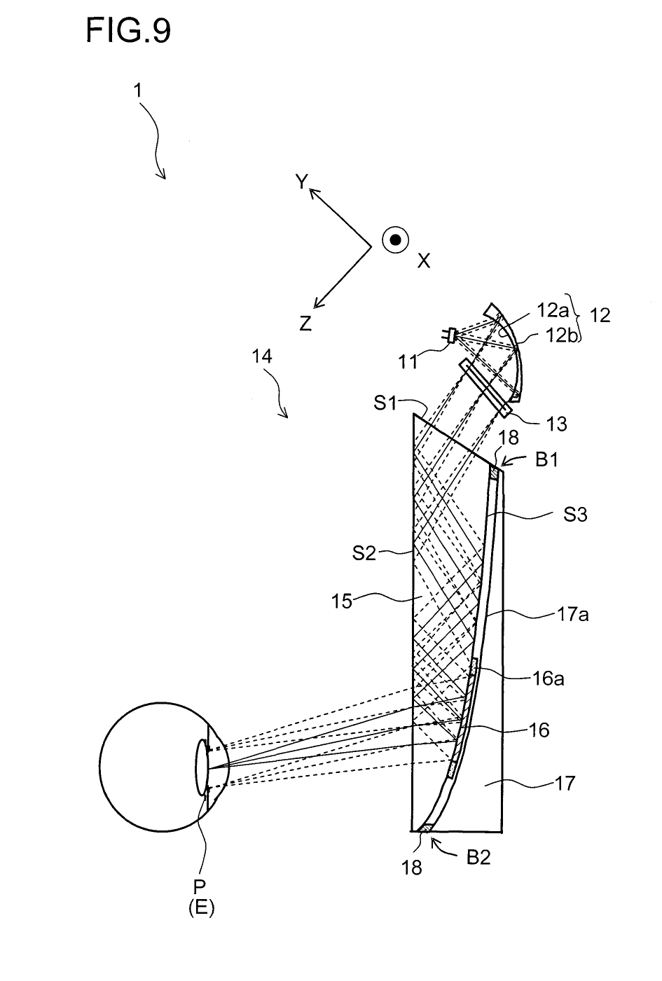

The HOE 16 only diffracts light of particular wavelengths incident at particular angles of incidence, and therefore exerts almost no effect on the transmission of outside light. Thus, while observing the displayed image (virtual image), the viewer can also observe an outside world image through the eyepiece prism 15 and the HOE 16 on a see-through basis. Although the outside world image suffers distortion as a result of its light being transmitted through the eyepiece prism 15, this distortion can be corrected for easily by attaching a correction prism 17 (see FIG. 9), which will be described later, to the eyepiece prism 15.

This embodiment adopts a construction where the surface S3 has both a total reflection surface and a diffraction-reflection surface (HOE surface), that is, a construction where a total reflection surface and a HOE surface are formed on the same surface S3. With this construction, as compared with one where those surfaces are formed separately, it is possible to reduce the angle of reflection on the HOE 16. Specifically, it is possible to set up the HOE on the surface S3 parallel to the surface S2, and this reduces the angle of incidence of the image light on the HOE 16; thus it is possible to reduce the angle of reflection (diffraction) on the HOE 16. By reducing the angle of diffraction on the HOE 16, it is possible to keep the color dispersion caused by diffraction small, and thus to maintain satisfactory image quality.

The eyepiece prism 15 is formed by the molding of resin such as acrylic resin. For easier molding at that time, and for securer attachment of the hologram photosensitive material 16a when it is attached, it is necessary to secure a larger HOE surface. With a construction where the HOE surface and the total reflection surface are formed as separate surfaces, forming a larger HOE surface results in making the eyepiece prism 15 thicker. By contrast, with the construction according to this embodiment, it is possible to form the HOE surface and the total reflection surface on the same surface to set up the HOE surface. It is thus possible, while avoiding making the eyepiece prism 15 thicker, to form a larger HOE surface, and thereby to achieve easier prism molding and securer attachment of the hologram photosensitive material 16a.

Moreover, in this embodiment, the eyepiece prism 15 has a tapering shape, that is, it is so shaped that the distance between the surfaces S2 and S3 continuously decreases away from the surface S1. Thus, as light is reflected between the surfaces S2 and S3, its angle of incidence with respect to the surface S2 or S3 decreases. This produces a greater difference in angle of incidence with respect to the surface S3 between a ray L1 that is reflected on the surface S2 once and then incident on the hologram photosensitive material 16a (surface S3) formed on the surface S3 and a ray that is reflected on the surface S2 twice, then reflected on the surface S3 once, and then incident on the HOE 16 (surface S3).

The volume-phase reflective HOE 16 has angle selectivity; thus, even if part of the image light, which should ideally be totally reflected, is incident on the region R2 within the attachment region R1 of the hologram photosensitive material 16a, that part of the image light is not readily diffraction-reflected toward the optical pupil E. Actually, that part of the image light is reflected on the HOE 16 (region R2) so as to be directed to the surface S2, is then totally reflected on the surface S2, is then incident back on the HOE 16 (region R2), and is diffraction-reflected by it so as to be directed to the optical pupil E. On the other hand, if part of the image light, which should ideally be totally reflected, is incident on the region R3 within the attachment region R1 of the hologram photosensitive material 16a, this part of the image light is totally reflected at the interface with the layer of air. This part of the image light is thereby directed to the surface S2, is then totally reflected on the surface S2, is then incident on the HOE 16 (region R2), and is diffraction-reflected by it so as to be directed to the optical pupil E. In either case, it is possible to prevent any part of the image light, which should ideally be totally reflected, incident on the attachment region R1 of the hologram photosensitive material 16a from being readily diffraction-directed there so as to be incident on the optical pupil E as ghost light.

It is thus no longer necessary, for the purpose of preventing occurrence of ghost light, to secure an optical path margin (a space for separating optical paths) between the diffraction-reflection region of the HOE 16 and the total reflection region for the image light, and this makes it possible to make the eyepiece prism 15 accordingly slimmer. That is, with the image display device 1 according to this embodiment, it is possible to prevent occurrence of ghost light and in addition make the eyepiece prism 15 slim and compact.

The hologram photosensitive material 16a is very thin, with a thickness of, for example, 20 nm. Thus, even when the hologram photosensitive material 16a partly overlaps the total reflection region for the image light on the surface S3, this does not degrade the optical performance of the image display device 1.

The HOE 16 in the eyepiece optical system 14 is used as a combiner which directs the image light from the display element 13 and the light of the outside world image simultaneously to the pupil P of a viewer. Thus, through the HOE 16, the viewer can observe the displayed image on the display element 13 and the outside image simultaneously. In particular, since the volume-phase reflective HOE 16 has high wavelength selectivity and a narrow reflection wavelength band, it is possible to present the viewer with a bright, easy-to-see image even when superimposed on the outside world image. Moreover, since the HOE 16 has an axis-asymmetric positive optical power, it is possible to increase flexibility in the arrangement of the individual optical members constituting the device, and thereby to make the device compact easily; in addition, it is possible to present the viewer with a satisfactorily aberration-corrected image.

(Shape of the Eyepiece Prism)

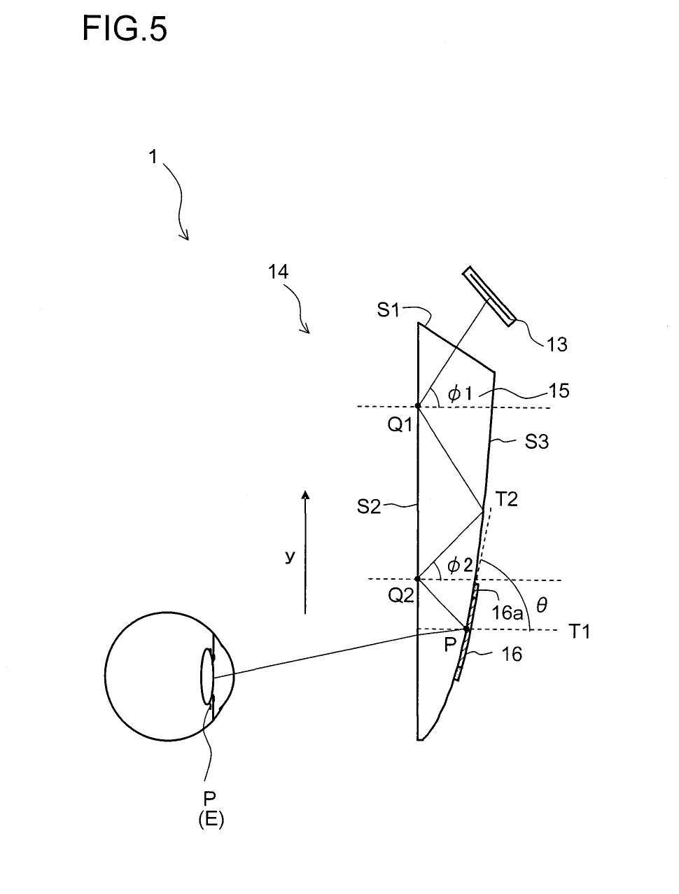

Next, the shape of the eyepiece prism 15 will be described in detail. FIG. 5 is a schematic sectional view of the eyepiece prism 15. In this embodiment, as described above, the eyepiece prism 15 has a tapering shape, that is, it is so shaped that the distance between the surfaces S2 and S3 continuously decreases away from the surface S1. Such a shape can be realized, for example, by fulfilling conditional formulae (1) and (2) below.

dθ/dy≧0 (1)

d²θ/ d²y≧0 (2)

where

θ represents, for any point P on the YZ plane at which a normal line T1 to the surface S2, which is a flat surface, intersects the surface S3, the angle between the tangent line T2 to the surface S3 at that point P and the normal line T1 to the surface S2 (0°≦θ≦90°); and

y represents the distance from the center of the optical pupil E to the point P in the direction along the surface S2 (the Y direction) on the YZ plane.

The variable θ is positive in the direction in which the angle from the normal line T1 increases.

When conditional formulae (1) and (2) are fulfilled, the point P on the surface S3 is located increasingly away from the surface S2 as y increases, and thus the surface S3 is shaped such that θ increases monotonously (a convex or flat surface). In other words, the distance between the surfaces S2 and S3 continuously decreases away from the surface S1. In this way, it is possible to set up an inclined HOE surface on the surface S3 and in addition make the eyepiece prism 15 slim. An eyepiece prism 15 with a flat surface S3 will be described later in connection with Embodiment 3.

Consider two points Q1 and Q2 on the surface S2, the point Q1 being closer to the surface S1; let the angle of incidence (in terms of reverse tracing, the angle of total reflection) of the axial ray (principal ray) with respect to the surface S2 at the point Q1 be φ1(°), and let the angle of incidence of the principal ray with respect to the surface S2 at the point Q2 be φ2(°). Then, since the above-discussed shape of the eyepiece prism 15 dictates that φ1>φ2, the display element 13 can be disposed close to right above the surface S1 of the eyepiece prism 15. This helps make the optical unit as a whole slim.

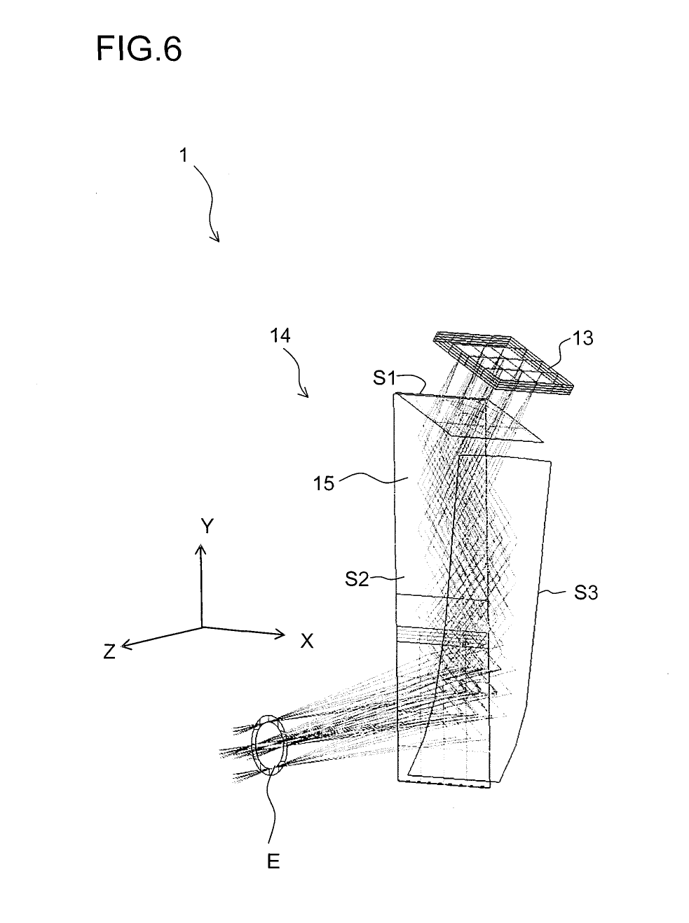

In this embodiment, the surface S3 of the eyepiece prism 15 has a curvature only on the YZ plane; however, it may have a curvature on the ZX plane as well. FIG. 6 is a perspective view of an image display device 1 incorporating an eyepiece prism 15 having a curvature on both of the just mentioned planes. Constructed in this way, the image display device 1 offers further improved optical performance (for example, aberration performance).

It is preferable that φ1 and φ2 be within the ranges defined by conditional formulae (3) and (4) below.

50°<φ1<70° (3)

40°<φ2<50° (4)

By holding φ1 and φ2 less than or equal to their respective upper limits, it is possible to prevent the eyepiece prism 15 from being unduly long in the up/down direction. It is then also possible to reduce the angle of incidence on the eyepiece prism 15, and thereby to reduce the angle of diffraction on the HOE 16. This makes it possible to prevent image deterioration resulting from occurrence of color dispersion caused by diffraction. On the other hand, by holding φ1 and φ2 more than or equal to their respective lower limits, it is possible to diminish the overlap between the total reflection region on the surface S3 and the diffraction region owing to the HOE 16. This makes it possible to prevent image deterioration due to occurrence of ghost light.

Table 1 lists the values of φ1 and φ2 as observed in the image display device of Embodiment 1, and in those of Embodiments 2 and 3, which will be described later. The listed values indicate that the image display devices of all these embodiments fulfill conditional formulae (3) and (4).

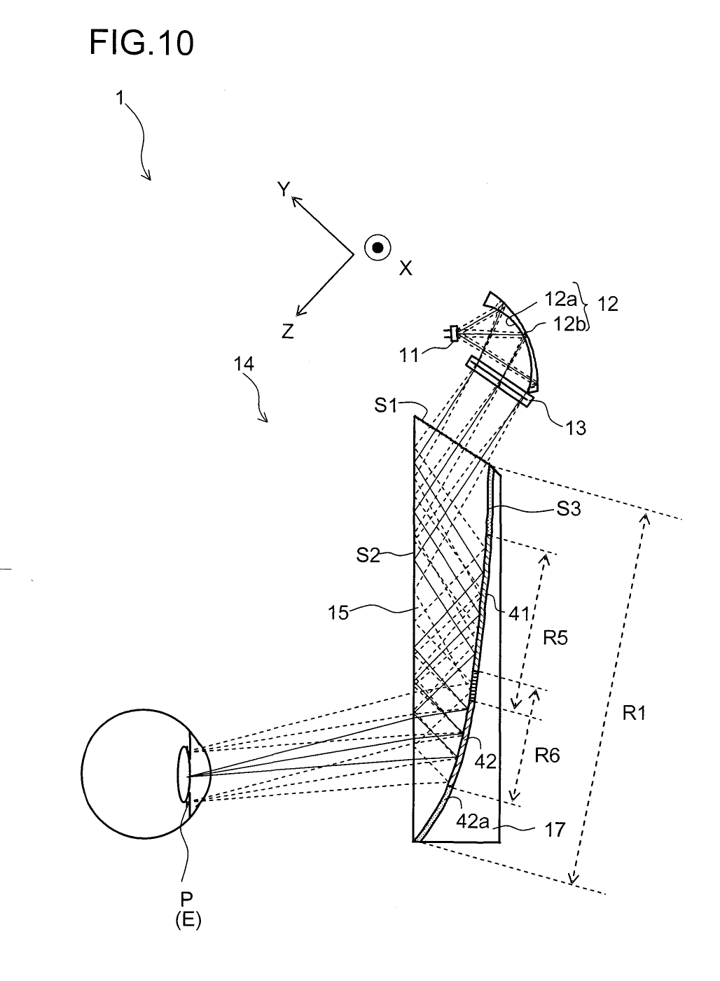

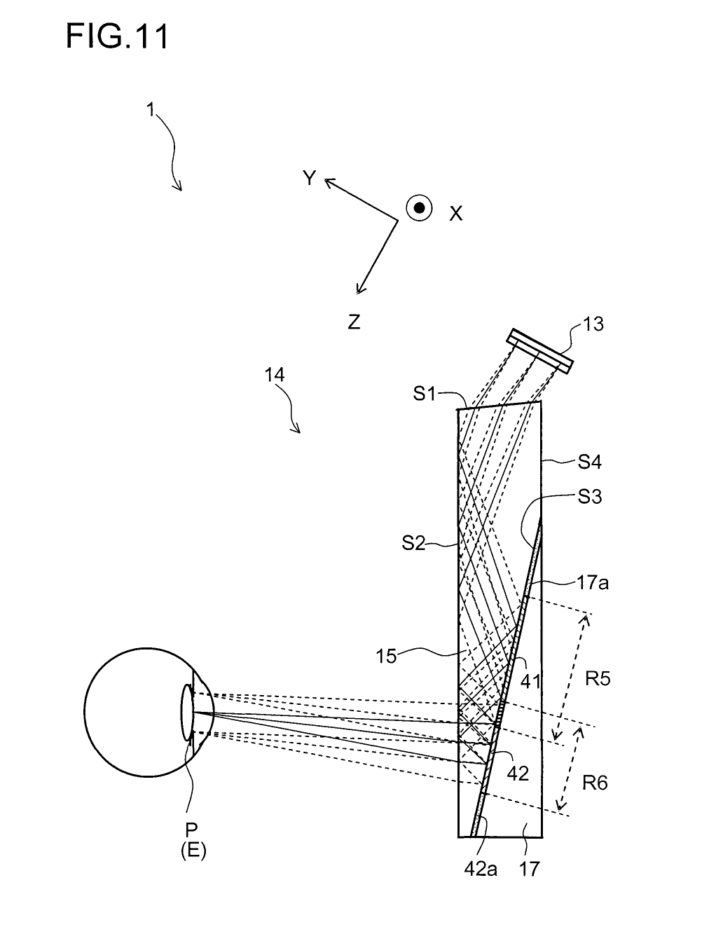

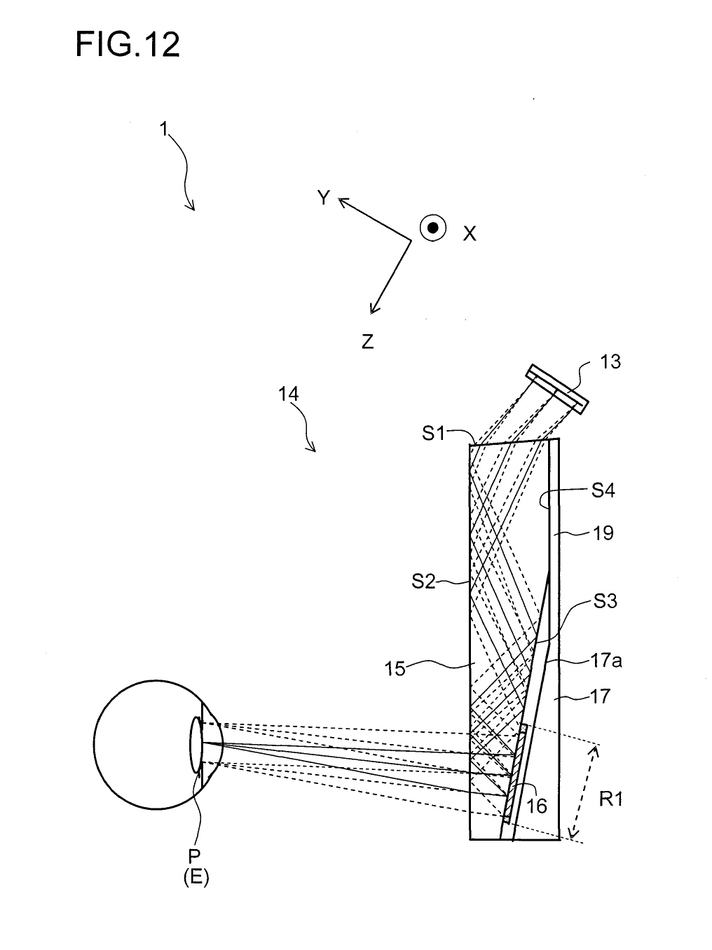

TABLE 1

| | Embod- | Embod- | | |
|---|---|---|---|---|
| | iment 1 | iment 2 | Embodiment 3 | Embodiment 3 |
| | (FIG. 2) | (FIG. 10) | (FIG. 11) | (FIG. 12) |
| φ1 (°) | 57.15 | 56.61 | 69.92 | 66.08 |
| (50° < φ1 < 70°) | | | | |
| φ2 (°) | 45.45 | 45.80 | 44.92 | 44.97 |
| 40° < φ2 < 50° | | | | |

(Method for Production of a HOE)

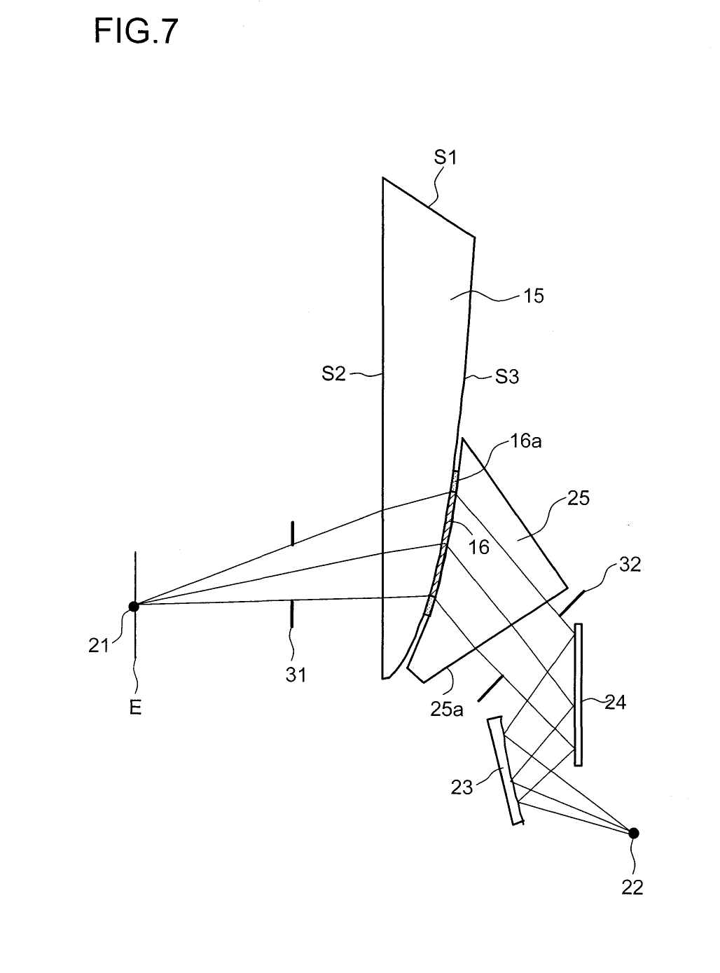

Next, how the HOE 16 mentioned above is produced will be described. FIG. 7 is a sectional view showing an outline of the construction of a production optical system for producing the HOE 16. The reflective HOE 16 is produced in the following manner: for each of R, G, and B, a laser beam is split into two beams, called the reference beam and the object beam respectively; a hologram photosensitive material 16a on a substrate (here, the eyepiece prism 15) is exposed, from both the substrate side and the opposite side, with the two beams (reference and object beams) respectively; by these two beams, interference fringes are recorded in the hologram photosensitive material 16a. Now, a description will be given of a specific method of producing the HOE 16. In the description to follow, the beam from the side where a viewer's eye is located is referred to as the reference beam, and the beam from the opposite side is referred to as the object light; moreover, it is assumed that the surface S3 of the eyepiece prism 15 is a surface that has a curvature only on the YZ plane.

First, the hologram photosensitive material 16a is attached to the surface S3 of the eyepiece prism 15. Usable as the hologram photosensitive material 16a is a photopolymer, a silver halide material, dichromated gelatin, or the like. Among these, a photopolymer is preferable because it allows easy production by a dry process.

Subsequently, in the production optical system, for each of R, G, and B, a laser beam is split into two beams by a beam splitter, and then the split beams (reference and object beams) are each condensed to become a divergent beam diverging from a point light source 21 or 22 respectively. The R, G, and B reference beams are spherical waves emitted from point light sources 21 located at an identical position, and are incident on the hologram photosensitive material 16a from the eyepiece prism 15 side. Here, the point light sources 21 for R, G, and B are located at the center of the optical pupil E of the eyepiece optical system 14 as it is during image observation. Instead, the point light sources 21 for R, G, and B may be arranged displaced from one another, but still on the optical pupil E, with consideration given to differences between the peak wavelengths of the light source 11 used during actual use and the emission wavelengths of the lasers used during production, and with consideration given also to the degree of contraction of the hologram photosensitive material 16a, so that, during actual use, the light of the R, G, and B peak wavelengths from the light source 11 (LEDs), after being diffracted by the HOE 16, falls at the same position on the optical pupil E.

On the other hand, the R, G, and B object beams are divergent beams emitted from point light sources 22 located at an identical position; these beams are shaped so as to have predetermined wavefronts by a free-form-surface mirror 23, are then reflected on a reflective mirror 24, and are then incident, through a color correction prism 25, on the hologram photosensitive material 16a from the side opposite from the eyepiece prism 15. Here, the surface 25a of the color correction prism 25 is disposed at such an angle as to cancel the chromatic aberration occurring mainly due to the image light being refracted at the surface S1 of the eyepiece prism 15 and at the surface S2 as the exit surface in the eyepiece optical system 14 used during actual use. To prevent ghosts resulting from surface reflection, it is preferable that the color correction prism 25 be disposed either in close contact with the hologram photosensitive material 16a or with a medium, such as emulsion oil, having the same index of refraction as the color correction prism 25 interposed in between.

Through the irradiation of the hologram photosensitive material 16a with (its exposure to) the reference and object beams as described above, interference fringes are recorded in the hologram photosensitive material 16a by those two beams, and in this way, the HOE 16 is produced.

At this time, the reference and object beams have their respective beam shapes restricted by beam restricting plates 31 and 32 so as to strike only the regions on the hologram photosensitive material 16a where to record the hologram (interference fringes). Accordingly, the formation region of the HOE 16 (meaning the region across which the HOE 16 is formed, corresponding to the region R2 in FIG. 1) on the surface S3 is smaller than the attachment region of the hologram photosensitive material 16a (corresponding to the attachment region R1 in FIG. 1).

As described above, the effective diffraction region within the attachment region of the hologram photosensitive material 16a where the HOE 16 is produced (the formation region of the HOE 16) is set by restricting the exposed region within the attachment region. This makes it possible to attach a hologram photosensitive material 16a larger than the effective diffraction region to the surface S3 and then restrict the exposed region, thereby to form the HOE 16 in a desired position. Consequently, it is possible to alleviate the positioning accuracy with which the hologram photosensitive material 16a needs to be attached on the surface S3. Moreover, by inserting the beam restricting plates 31 and 32 in the optical path of the production optical system and thereby restricting the beam diameters of the two beams to which the hologram photosensitive material 16a is exposed, it is possible to restrict the exposed region easily and accurately.

Moreover, since the surface S3 of the eyepiece prism 15 has a curvature only on the YZ plane, it is possible to attach the hologram photosensitive material 16a in sheet form to the surface S3 easily, thereby to produce the HOE 16. This makes the production of the HOE 16 easy.

(Another Construction of the Image Display Device)

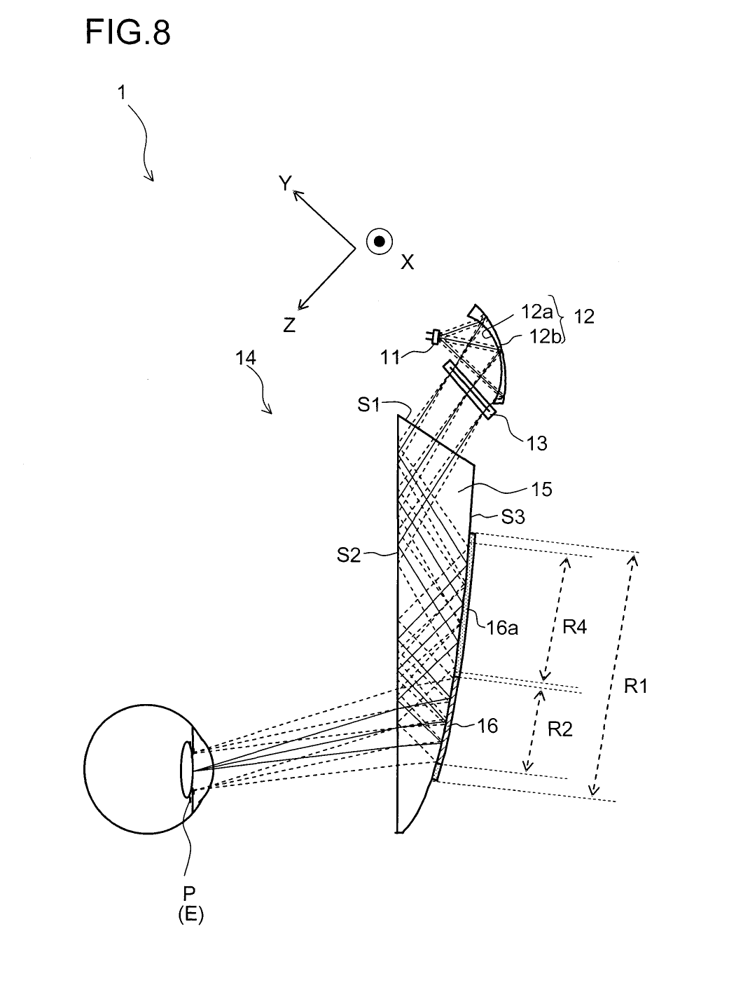

FIG. 8 is a sectional view showing another construction of the image display device 1. As shown there, in the image display device 1, the attachment region R1 of the hologram photosensitive material 16a may include all of the region R2 as the diffraction-reflection region and a total-reflection region R4 for the image light on the surface S3.

In this case, the hologram photosensitive material 16a is so large as to include both of the regions R2 and R4, and therefore these two regions R2 and R4 are optically continuous at their border. Thus, the viewer can observe a satisfactory image all across the screen (image region). Also when observing an outside world image on a see-through basis, the viewer observes it through the hologram photosensitive material 16a (including the HOE 16) all across the field of view, and thus the viewer can observe the outside world image as a uniform image (not as a discontinuous image).

(Yet Another Construction of the Image Display Device)

FIG. 9 is a sectional view showing yet another construction of the image display device 1. As shown there, in the image display device 1, the eyepiece optical system 14 may further include a correction prism 17 and a positioning portion 18.

The correction prism 17 is a prism for canceling the refraction of the light of the outside world image at the eyepiece prism 15. The positioning portion 18 is a projection (spacer) for joining together the eyepiece prism 15 and the correction prism 17 at a predetermined interval from each other with a layer of air in between, and is formed on at least one of the eyepiece prism 15 and the correction prism 17.

In particular, the eyepiece prism 15 and the correction prism 17 are joined together with two positioning portions 18 interposed in between in such a way that a layer of air is formed between the total reflection region for the image light on the surface S3 of the eyepiece prism 15 and the surface 17a of the correction prism 17 facing the surface S3, and that a layer of air is also formed between the attachment region of the hologram photosensitive material 16a and the surface 17a. Here, the joint lines B1 and B2 along which the eyepiece prism 15 and the correction prism 17 are joined together are located on side surfaces that intersect the surfaces (for example, the surfaces S2 and S3) through which the light of the outside world image is transmitted.

In a case where, as shown in FIG. 9, the eyepiece prism 15 is so shaped as to be increasingly thin away from the surface S1, due to the light of the outside world image being refracted at the surfaces S2 and S3, the outside world image observed through the eyepiece prism 15 suffers distortion. By joining, however, the correction prism 17 to the eyepiece prism 15 with a layer of air and a positioning portion 18 interposed in between to substantially form a parallel plate as a whole, and allowing observation of the outside world image through the eyepiece prism 15 and the correction prism 17, it is possible to prevent the observed outside world image from suffering distortion.

Moreover, in the eyepiece optical system 14, all the joint lines B1 and B2 are located on surfaces that intersect the surfaces through which the light of the outside world image is transmitted, and thus, when the outside world image is observed on a see-through basis, the joint lines B1 and B2 are located outside the field of view. This permits the viewer to observe the outside world image satisfactorily. Moreover, the eyepiece prism 15 and the correction prism 17 then have a flat part at the tip end. This makes the molding of these prisms easy, makes their attachment easy, and thus helps reduce cost.

Moreover, owing to the positioning portion 18, the eyepiece prism 15 and the correction prism 17 can be kept at a predetermined interval from each other with a layer of air in between. This makes it possible to ensure that the image light is totally reflected inside the eyepiece prism. In particular, by providing a layer of air also between the attachment region of the hologram photosensitive material 16a and the surface 16a of the correction prism 17, even if part of the image light, which should ideally be totally reflected, is incident on a region within the attachment region of the hologram photosensitive material 16a but outside the effective diffraction region, it is possible to ensure that that part of the image light is totally reflected at the interface with the layer.

### Embodiment 2

Another embodiment of the invention will be described below with reference to the accompanying drawings. For convenience' sake, in the following description, such parts as are found in Embodiment 1 will be identified with the same reference signs, and no overlapping description will be repeated.

FIG. 10 is a sectional view showing an outline of the construction of an image display device 1 according to this embodiment. In the image display device 1 of this embodiment, two kinds of HOE are produced on the surface S3 of the eyepiece prism 15 in the eyepiece optical system 14, and with these two kinds of HOE in between, the eyepiece prism 15 and the correction prism 17 are joined together. The two kinds of HOE are both volume-phase reflective HOEs.

Of those HOEs, one will be referred to as the first HOE 41, and the other will be referred to as the second HOE 42. The second HOE 42 is produced by exposing a hologram photosensitive material 42a attached over the entire surface S3 to the two beams. The first HOE 41 too is produced by exposing the hologram photosensitive material 42a to the two beams. Thus, the attachment region R1 of the hologram photosensitive material 42a where the second HOE 42 is produced includes a diffraction-reflection region R6 of the second HOE 42 and a diffraction-reflection region R5 of the first HOE 41.

Moreover, in this embodiment, as shown in FIG. 10, the diffraction-reflection region R6 of the second HOE 42 and the diffraction-reflection region R5 of the first HOE 41 partly overlap. That is, in part of the hologram photosensitive material 42a, interference fringes for the first HOE 41 and interference fringes for the second HOE 42 are both formed by multiple exposure. Thus, part of the beam of the image light diffraction-reflected by the first HOE 41 is incident also on the diffraction-reflection region R6 of the second HOE 42.

In the construction described above, the image light from the display element 13 enters the eyepiece prism 15 through the surface S1, is then diffraction-reflected by the first HOE 41 on the surface S3 at least once, is then totally reflected on the surface S2, and is then diffraction-reflected by the second HOE 42 on the surface S3 so as to be directed to the optical pupil E. With this construction, where the surface S3 has a diffraction-reflection surface (first HOE surface) owing to the first HOE 41 and a diffraction-reflection surface (second HOE surface) owing to the second HOE 42, that is, where two HOE surfaces are formed on the same surface S3, it is possible to set up a second HOE surface in a direction parallel to the surface S2. This reduces the angle of incidence of the image light on the second HOE 42, and thus makes it possible to reduce the angle of reflection (diffraction) on the second HOE 42. By reducing the angle of diffraction on the second HOE 42, it is possible to reduce the color dispersion caused by diffraction, and thus to maintain satisfactory image quality.

Moreover, since, as in Embodiment 1, the distance between the surfaces S2 and S3 continuously decreases away from the surface S1, even with a construction where part of the beam of the image light diffraction-reflected by the first HOE 41 on the surface S3 is incident on the diffraction-reflection region R6 of the second HOE 42, the part of the image light that is incident on the diffraction-reflection region R6 of the second HOE 42 despite the fact that the image light should ideally be diffraction-reflected (for example, regularly reflected) by the first HOE 41 can be diffraction-reflected (for example, diffracted at an angle of reflection close to that for regular reflection) on the diffraction-reflection region R6 of the second HOE 42. That is, since a volume-phase reflective HOE has angle selectivity, even if part of the image light, which should ideally be totally reflected, is incident on the second HOE 42, that part of the image light is not diffraction-reflected by it toward the optical pupil E. It is thus no longer necessary, for the purpose of preventing occurrence of ghost light, to secure an optical path margin (a space for separating optical paths) between the diffraction-reflection region R5 of the first HOE 41 and the diffraction-reflection region R6 of the second HOE 42, and this makes it possible to make the eyepiece prism 15 accordingly slimmer. Thus, with the construction described above, it is possible to prevent occurrence of ghost light and in addition make the eyepiece prism 15 slim and compact.

Moreover, the attachment region R1 of the hologram photosensitive material 42a, where the second HOE 42 is produced, includes both the diffraction-reflection region R6 of the second HOE 42 and the diffraction-reflection region R5 of the first HOE 41, and the hologram photosensitive material 42a is so large as to include both of the diffraction-reflection regions R5 and R6; thus, these regions are optically continuous at their boundary. Thus, the viewer can observe a satisfactory image all across the screen (image region). Also when observing an outside world image on a see-through basis, the viewer observes it through the hologram photosensitive material 42a (including the diffraction-reflection regions R5 and R6) all across the field of view, and thus the viewer can observe the outside world image as a uniform image (not as a discontinuous image). Furthermore, when the correction prism 17 is attached to the eyepiece prism 15, it is possible to join the eyepiece prism 15 and the correction prism 17 together with no layer of air in between, and thus to join them together stably.

Moreover, in part of the hologram photosensitive material 42a, interference fringes for the first HOE 41 and interference fringes for the second HOE 42 are both formed by multiple exposure. Thus, even if part of the beam of the image light diffraction-reflected by the first HOE 41 is incident on the diffraction-reflection region R6 of the second HOE 42, it is possible to ensure that that part of the image light is diffraction-reflected (for example, diffracted at an angle of reflection close to that for regular reflection) by the interference fringes of the first HOE 41. Moreover, by making the angle of diffraction on the first HOE 41 close to that for regular reflection, it is possible to suppress occurrence of color dispersion.

In this embodiment, one kind of hologram photosensitive material, that is, the hologram photosensitive material 42a for producing the second HOE 42, is subjected to two types of exposure to produce two kinds of HOEs (the first and second HOEs 41 and 42). Instead, it is also possible to prepare two kinds of hologram photosensitive material, then attach one hologram photosensitive material to the surface S3 and expose it to produce the second HOE 42, then treat it by a fixing process, and thereafter attach the other hologram photosensitive material to the surface S3 and expose it to produce the first HOE 41. Here, it is also possible to attach the two hologram photosensitive materials to the surface S3 in such a way that they party overlap and expose them to produce the two kinds of HOE.

### Embodiment 3

Yet another embodiment of the invention will be described with reference to the accompanying drawings. For convenience' sake, in the following description, such parts as are found in Embodiment 1 or 2 will be identified with the same reference signs, and no overlapping description will be repeated.

FIG. 11 is a sectional view showing an outline of the construction of an image display device 1 according to this embodiment. The image display device 1 of this embodiment has a similar construction to that of Embodiment 2, the differences being that the eyepiece prism 15 has a flat surface as the surface S3, has a surface S4 substantially parallel to the surface S2, and has the surfaces S1 and S3 connected together by the surface S4 outside the effective optical path region of the image light. The correction prism 17 is here so disposed that the surface 17a only faces the surface S3 across the two kinds of HOE.

By making the surface S3 flat, it is possible to make the surface 17a of the correction prism 17 facing the surface S3 flat, and thereby to simplify the structures of the eyepiece prism 15 and the correction prism 17. Moreover, if, for example, the surface S3 and the surface 17a are both curved surfaces, the eyepiece prism 15 and the correction prism 17 may make partial contact with each other when joined together; by contrast, with the surface S3 and the surface 17a both being flat surfaces, when the eyepiece prism 15 and the correction prism 17 are joined together, even if the interval between them is small, it is possible to join them together while preventing them from making partial contact with each other. This makes joining the eyepiece prism 15 and the correction prism 17 together easy.

Moreover, connecting the surface S4 of the eyepiece prism 15 to the surface S3 outside the effective optical path region of the image light permits the surfaces S2 and S4 to be parallel outside the effective optical path region, and this makes it possible to make the eyepiece prism 15 slim.

FIG. 12 is a sectional view showing another construction of the image display device 1. This image display device 1 has a combination of the above-described construction shown in FIG. 9 and the construction shown in FIG. 11 having a flat surface as the surface S3, with the positioning portion 18 omitted and the correction prism 17 given a slightly modified shape. That is, the surface S3 of the eyepiece prism 15 and the surface 17a of the correction prism 17 are flat surfaces, and the correction prism 17 has a positioning portion 19. The positioning portion 19, when the eyepiece prism 15 and the correction prism 17 are joined together, makes contact with the surface S4 of the eyepiece prism 15 outside the total reflection region and thereby serves to position the correction prism 17 relative to the eyepiece prism 15. The positioning portion 19 extends from the correction prism 17 parallel to the surface S4.

With this construction, by putting the positioning portion 19 of the correction prism 17 in contact with the surface S4 of the eyepiece prism 15, it is possible to achieve positioning easily. Moreover, the joint line between the eyepiece prism 15 and the correction prism 17 is located on the same surface as the surface Si and hence outside the observation region of the outside world image; thus, the viewer can observe the outside world image satisfactorily.

### Embodiment 4

Still another embodiment of the invention will be described with reference to the accompanying drawings. For convenience' sake, in the following description, such parts as are found in any of Embodiments 1 to 3 will be identified with the same reference signs, and no overlapping description will be repeated.

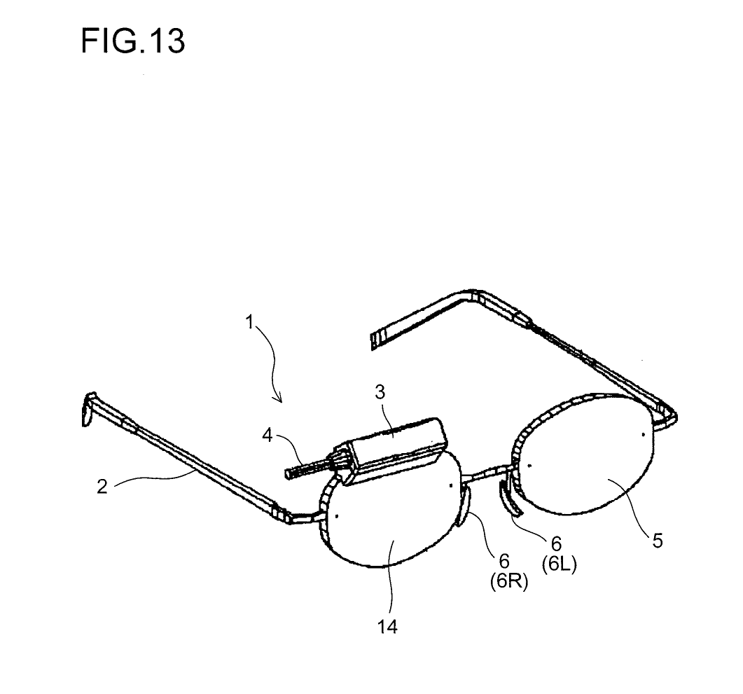

FIG. 13 is a perspective view showing an outline of the construction of a HMD according to this embodiment. This HMD is composed of an image display device 1 according to any of the embodiments described previously and a support member 2.

The image display device 1 has a light source 11 and a display element 13 (see FIG. 1) housed in a housing 3, and has an eyepiece optical system 14 integrated with the housing 3. The signals and supply electric power for controlling the light source 11 and the display element 13 are fed to their respective destinations via a cable 4 that penetrates the housing 3. The eyepiece optical system 14 is as a whole shaped like one (in FIG. 13, the one for the right eye) of the lenses of spectacles (eyeglasses). As a lens 5 corresponding to the other, for the left eye, of the lenses of spectacles, a dummy lens is provided.

The support member 2 serves as a supporting means whereby the image display device 1 is supported in front of an eye of a viewer, and is composed of, for example, a set of members corresponding to the frame and temples of spectacles. When the support member 2 is fixed on the viewer's head, the image display device 1 is held in an accurate position in front of his eye; thus, the viewer can observe the image presented by the image display device 1 in a hands-free fashion stably for a long time. In particular, according to the present invention, it is possible to make the eyepiece prism 15 in the eyepiece optical system 14 slim and compact, and thus to realize a compact, lightweight HMD. Whereas in this embodiment the support member 2 supports one image display device 1 corresponding to the viewer's right eye, it may instead support two image display devices corresponding to both eyes of the viewer.

The support member 2 has a fixing mechanism 6. The fixing mechanism 6 serves as a fixing means whereby, after the position of the optical pupil E is adjusted to the viewer's pupil P (anatomical pupil, iris), the eyepiece optical system 14 is kept in a fixed position relative to the viewer's head. The fixing mechanism 6 is composed of a right nose pad 6R and a left nose pad 6L, which movably make contact with the viewer's nose, and a locking portion which locks them. Owing to the support member 2 having the fixing mechanism 6, after the position adjustment of the optical pupil, the viewer can observe a satisfactory image at the position of the optical pupil without fail and stably for a long time.

Although the embodiments deal with examples where the light source 11 is composed of LEDs, the light source 11 may be a laser light source. Using a laser light source makes it possible to eliminate the effect of the dispersion caused by diffraction on a HOE, and thus permits the viewer to observe a high-quality, bright image.

Needless to say, it is possible to build an image display device 1, and hence a HMD, by combining features from different embodiments together appropriately.

Any of the image display devices 1 described above as embodiments may also be applied to, for example, a head-up display (HUD).

### INDUSTRIAL APPLICABILITY

The present invention find applications in HMDs and HUDs.

### LIST OF REFERENCE SIGNS

1 image display device
2 support member (support means)
13 display element
14 eyepiece optical system
15 eyepiece prism
16 HOE
16a hologram photosensitive material
17 correction prism
18 positioning portion
19 positioning portion
41 first HOE
42 second HOE
42a hologram photosensitive material
E optical pupil
R1 attachment region
R2 region (effective diffraction region)
R3 region
R4 total-reflection region
R5 diffraction-reflection region
R6 diffraction-reflection region
S1 surface
S2 surface
S3 surface

1.-11. (canceled)

12. An image display device comprising:
a display element for displaying an image; and
an eyepiece optical system for directing image light from the display element to an optical pupil, the eyepiece optical system comprising:
an eyepiece prism having a surface S1 on which the image light is incident, a surface S2 which is disposed toward the optical pupil, and a surface S3 which is disposed opposite from the surface S2, and
a volume-phase reflective holographic optical element formed on part of the surface S3,
wherein
the image light from the display element enters the eyepiece prism through the surface S1, is then totally reflected on the surface S3 at least once, is then totally reflected on the surface S2, and is then diffraction-reflected by the holographic optical element on the surface S3 so as to be directed to the optical pupil,
when an axis optically connecting a center of a display screen of the display element to a center of the optical pupil is defined as an optical axis, and a plane including an optical axis of light incident on the surface S3 and an optical axis of light emergent from the surface S3 is defined as an optical axis incidence plane, then the eyepiece prism is shaped symmetrically about the optical axis incidence plane and is so shaped that a distance between the surfaces S2 and S3 continuously decreases away from the surface S1, and
at least part of a beam of the image light totally reflected on the surface S3 is incident on an attachment region of an hologram photosensitive material where the holographic optical element is produced.

13. The image display device according to claim 12,
wherein an effective diffraction region within the attachment region of the hologram photosensitive material where the holographic optical element is, or the holographic optical elements are, produced is set by restricting an exposed region within the attachment region.

14. The image display device according to claim 12,
wherein the attachment region of the hologram photosensitive material where the holographic optical element is produced includes a diffraction-reflection region and a total reflection region for the image light on the surface S3.

15. The image display device according to claim 12,
wherein the surface S3 has a curvature only on the optical axis incidence plane.

16. The image display device according to claim 12, further comprising a correction prism for canceling refraction of light of an outside world image in the eyepiece prism,
wherein any joint line along which the eyepiece prism and the correction prism are joined together is located on a side face that intersects a surface through which the light of the outside world image is transmitted.

17. The image display device according to claim 12, further comprising a correction prism for canceling refraction of light of an outside world image in the eyepiece prism,
wherein at least one of the eyepiece prism and the correction prism comprises a positioning portion for joining together the eyepiece prism and the correction prism at a predetermined interval from each other with a layer of air in between.

18. The image display device according to claim 12,
wherein the surface S3 is a flat surface.

19. An image display device comprising:
a display element for displaying an image; and
an eyepiece optical system for directing image light from the display element to an optical pupil, the eyepiece optical system comprising:
an eyepiece prism having a surface S1 on which the image light is incident, a surface S2 which is disposed toward the optical pupil, and a surface S3 which is disposed opposite from the surface S2,
a first volume-phase reflective holographic optical element formed on the surface S3, and
a second volume-phase reflective holographic optical element formed on the surface S3,
the image light from the display element enters the eyepiece prism through the surface S1, is then diffraction-reflected by the first holographic optical element on the surface S3 at least once, is then totally reflected on the surface S2, and is then diffraction- reflected by the second holographic optical element on the surface S3 so as to be directed to the optical pupil,
when an axis optically connecting a center of a display screen of the display element to a center of the optical pupil is defined as an optical axis, and a plane including an optical axis of light incident on the surface S3 and an optical axis of light emergent from the surface S3 is defined as an optical axis incidence plane, then the eyepiece prism is shaped symmetrically about the optical axis incidence plane and is so shaped that a distance between the surfaces S2 and S3 continuously decreases away from the surface S1, and
part of a beam of the image light diffraction-reflected by the first holographic optical element is incident on a diffraction-reflection region of the second holographic optical element.

20. The image display device according to claim 19,
wherein an effective diffraction region within the attachment region of the hologram photosensitive material where the holographic optical element is, or the holographic optical elements are, produced is set by restricting an exposed region within the attachment region.

21. The image display device according to claim 19,
wherein the attachment region of the hologram photosensitive material where the second holographic optical element is produced includes the diffraction-reflection region of the second holographic optical element and a diffraction-reflection region of the first holographic optical element.

22. The image display device according to claim 21,
wherein, in part of the hologram photosensitive material, interference fringes for the first holographic optical element and interference fringes for the second holographic optical element are both formed by multiple exposure.

23. The image display device according to claim 19,
wherein the surface S3 has a curvature only on the optical axis incidence plane.

24. The image display device according to claim 19, further comprising a correction prism for canceling refraction of light of an outside world image in the eyepiece prism,
wherein any joint line along which the eyepiece prism and the correction prism are joined together is located on a side face that intersects a surface through which the light of the outside world image is transmitted.

25. The image display device according to claim 19, further comprising a correction prism for canceling refraction of light of an outside world image in the eyepiece prism,
wherein at least one of the eyepiece prism and the correction prism comprises a positioning portion for joining together the eyepiece prism and the correction prism at a predetermined interval from each other with a layer of air in between.

26. The image display device according to claim 19,
wherein the surface S3 is a flat surface.

27. A head-mounted display comprising:
an image display device; and
a supporting mechanism for supporting the image display device in front of an eye of a viewer, the image display device comprising:
a display element for displaying an image; and
an eyepiece optical system for directing image light from the display element to an optical pupil, the eyepiece optical system comprising:
an eyepiece prism having a surface S1 on which the image light is incident, a surface S2 which is disposed toward the optical pupil, and a surface S3 which is disposed opposite from the surface S2, and
a volume-phase reflective holographic optical element formed on part of the surface S3,
wherein
the image light from the display element enters the eyepiece prism through the surface S1, is then totally reflected on the surface S3 at least once, is then totally reflected on the surface S2, and is then diffraction-reflected by the holographic optical element on the surface S3 so as to be directed to the optical pupil,
when an axis optically connecting a center of a display screen of the display element to a center of the optical pupil is defined as an optical axis, and a plane including an optical axis of light incident on the surface S3 and an optical axis of light emergent from the surface S3 is defined as an optical axis incidence plane, then the eyepiece prism is shaped symmetrically about the optical axis incidence plane and is so shaped that a distance between the surfaces S2 and S3 continuously decreases away from the surface S1, and
at least part of a beam of the image light totally reflected on the surface S3 is incident on an attachment region of an hologram photosensitive material where the holographic optical element is produced.

28. The head-mounted display according to claim 27,
wherein the attachment region of the hologram photosensitive material where the holographic optical element is produced includes a diffraction-reflection region and a total reflection region for the image light on the surface S3.

29. A head-mounted display comprising:
an image display device; and
a supporting mechanism for supporting the image display device in front of an eye of a viewer, the image display device comprising:
a display element for displaying an image; and
an eyepiece optical system for directing image light from the display element to an optical pupil, the eyepiece optical system comprising:
an eyepiece prism having a surface S1 on which the image light is incident, a surface S2 which is disposed toward the optical pupil, and a surface S3 which is disposed opposite from the surface S2,
a first volume-phase reflective holographic optical element formed on the surface S3, and
a second volume-phase reflective holographic optical element formed on the surface S3,
the image light from the display element enters the eyepiece prism through the surface S1, is then diffraction-reflected by the first holographic optical element on the surface S3 at least once, is then totally reflected on the surface S2, and is then diffraction-reflected by the second holographic optical element on the surface S3 so as to be directed to the optical pupil,
when an axis optically connecting a center of a display screen of the display element to a center of the optical pupil is defined as an optical axis, and a plane including an optical axis of light incident on the surface S3 and an optical axis of light emergent from the surface S3 is defined as an optical axis incidence plane, then the eyepiece prism is shaped symmetrically about the optical axis incidence plane and is so shaped that a distance between the surfaces S2 and S3 continuously decreases away from the surface S1, and
part of a beam of the image light diffraction-reflected by the first holographic optical element is incident on a diffraction-reflection region of the second holographic optical element.

30. The head-mounted display according to claim 29,
wherein the attachment region of the hologram photosensitive material where the second holographic optical element is produced includes the diffraction-reflection region of the second holographic optical element and a diffraction-reflection region of the first holographic optical element.
